(19) United States
(12) Patent Application Publication
(10) Pub. No.: US 2009/0089396 A1
(43) Pub. Date: Apr. 2, 2009

(54) Integrated Method of Enabling a Script-Embedded Web Browser to Interact with Drive-Based Contents

(76) Inventors: Yuxi Sun, Fremont, CA (US); Xun Fang, Livermore, CA (US); Xiaobing Yu, Binjiang District (TW); Jun Liu, Binjiang District (TW)

Correspondence Address: GLENN PATENT GROUP, 3475 EDISON WAY, SUITE L, MENLO PARK, CA, 94025, US

(21) Appl. No.: 12/238,350

(22) Filed: Sep. 25, 2008

Related U.S. Application Data
(60) Provisional application No. 60/975,724, filed on Sep. 27, 2007.

(51) Int. Cl. G06F 15/16

(52) U.S. Cl. 709/217

(57) ABSTRACT

A web browser displays a web page containing an embedded script. Middleware on a web server uses a script parser to parse the information generated by the embedded script. The media file is transmitted from an Internet server or servers. The middleware sends indexable information to a database server and the downloaded media file to a storage device. The next time that a user selects the media for playback, the file is directly streamed from the storage device. The storage device is local mounted or network mounted.

### CROSS REFERENCE TO RELATED APPLICATIONS

This patent application claims the benefit of U.S. provisional patent application Ser. No. 60/975,724, Quick Searching Facility for Virtualized Environment, filed Sep. 27, 2007, the entirety of which is incorporated herein by this reference thereto.

### BACKGROUND OF THE INVENTION

1. Technical Field

This invention relates generally to the field of personal computers. More specifically, this invention relates to a script-embedded web browser that interacts with a local or network-mounted drive.

2. Description of the Related Art

A browser is a software program that runs on a client computer and that allows users to access the Internet via the World Wide Web (WWW). When the Internet first became popular in the 1990s, only a few browsers, e.g. Mosaic (eventually named Netscape Navigator) and Microsoft Internet Explorer were used. Soon, however, companies competed to create a browser to dominate the WWW. Currently, there are a plethora of browsers to choose from depending upon the user's preferences, e.g. Microsoft Internet Explorer, Mozilla Firefox, Apple Safari, Opera, Google Chrome.

The World Wide Web Consortium (W3C) was formed to ensure compatibility and agreement among members for the adoption of a set of core principles. W3C developed a set of recommendations for web standards. As a result, browsers are designed to display any W3C compliant web pages.

Web pages can contain text, images, audio clips, visual clips, etc. One way to watch videos from a web page is to download the file and play it on a local multimedia player. This approach, however, is time consuming because the user must download the entire file before it is accessible. More importantly, the video format may be incompatible with a user's multimedia player. A website may provide multiple versions of the same file, but because of the variety of platforms, browsers, and media players, this method of viewing the video clip is plagued with problems.

Another method for viewing video clips is to embed video into the webpage itself. A user can then watch the video clip by downloading a plug-in onto a client and selecting the video clip for streaming directly from the website. Adobe Flash, for example, is a plug-in that interacts with the website to enable streaming of embedded audio and video clips. Files in the SWF format can be played in a standalone Flash Player or a self-executing Flash movie. Flash is installed in 98% of all Internet-enabled personal computers. Flash supports a variety of platforms including Windows, Mac OS X, and Linux and a variety of browsers including Microsoft Internet Explorer, Mozilla Firefox, Safari, and Opera. This avoids the issue of compatibility of file formats and media players altogether. YouTube is an example of a website that provides embedded video clips using Flash. These video clips can only be accessed while the user is online.

The drawback to watching any embedded video is that the data stream must still be buffered each time a user selects the video clip for playback. In addition, the process of playing media clips is a complex process. With each additional step comes a greater chance of encountering an error.

Gears is a plug-in created by Google that enables web applications to work offline. Gears contains three modules that work offline: a local server, a database, and a workerpool. The local server saves application resources, such as HTML, JavaScript, and images locally. The database stores data locally in a searchable relational database. The database is powered by SQLite. The workerpool allows web applications to run JavaScript code in the background. When a user launches a browser, Gears determines whether the user is online or offline. If the user is offline, Gears provides a cached version of the webpage.

### SUMMARY OF THE INVENTION

In one embodiment, a script embedded in a web browser interfaces with a local or network-mounted drive, e.g. a hard drive, a USB drive, or other types of mounted storage for faster playback of video clips and offline viewing. Thus, a user can view media clips locally while the server is offline. Alternatively, the user can access a home entertainment server from anywhere as long as the web browser includes a compatible plug-in, e.g. Flash.

### BRIEF DESCRIPTION OF THE DRAWINGS

FIG. 1 is a block diagram that illustrates a system for enabling an embedded script on a web browser to access storage according to one embodiment of the invention;

FIG. 2 is a block diagram of the system components according to one embodiment of the invention; and

FIG. 3 is a flowchart that illustrates the steps for accessing media on a web browser where the web browser can access contents stored on a drive according to one embodiment of the invention.

### DETAILED DESCRIPTION OF THE INVENTION

In one embodiment, the invention comprises a method and/or an apparatus for storing media files from a web browser containing an embedded script.

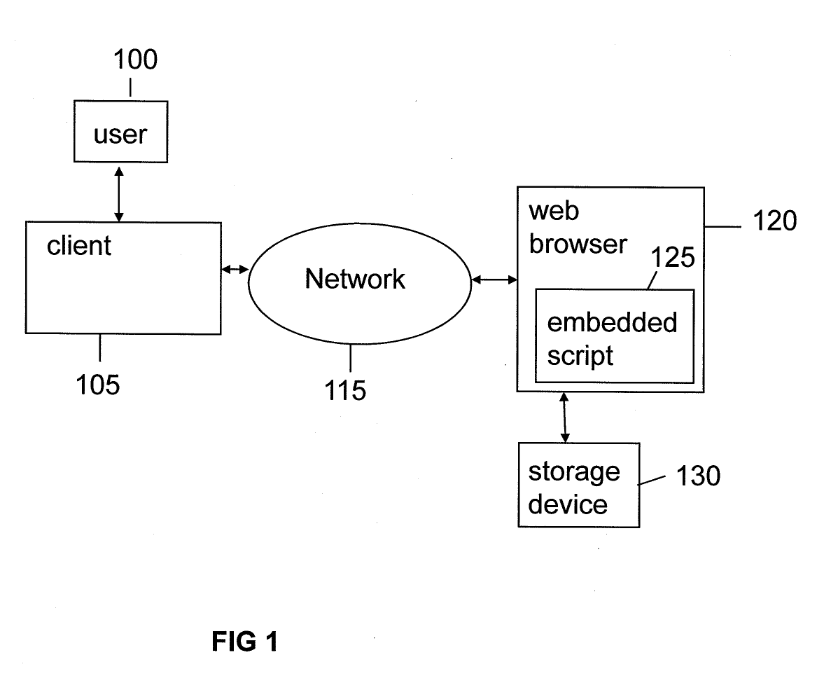

FIG. 1 is a simplified block diagram that illustrates a system for enabling an embedded script 125 on a web-browser 120 to interact with storage 130 according to one embodiment of the invention. A user 100 uses a client 105, e.g. a computing platform configured to act as a client device such as a computer, a digital media player, a personal digital assistant, or a cellular telephone.

The user 100 accesses a web browser 120 over the network 115. The web browser 120 contains an embedded script 125, e.g. Flash. The first time that a web page is accessed, the media content for display on the browser 120 is streamed from an Internet server via a network 115. The network 115 can be, e.g. a local area network (LAN), a wide area network (WAN), the Internet. In one embodiment, the network 115 is implemented via wireless and/or wired solutions.

### Key Components

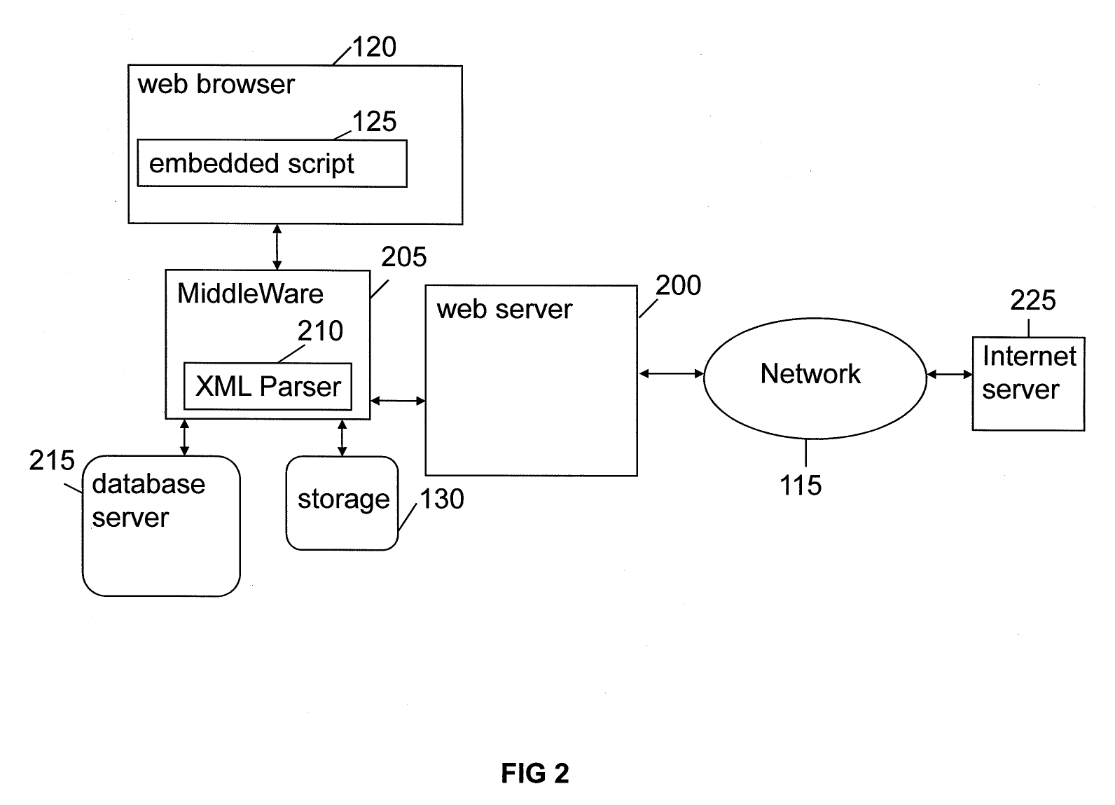

The system comprises six key components: (1) a standard-based web browser 120 containing (2) frontend scripting 125, (3) a web server 200, (4) middleware 205 containing an XML parser 210, (5) a database server 215 including a RDBMS database, and (6) local storage 130. FIG. 2 is a block diagram of the system according to one embodiment of the invention.

Browser

The browser 120 can be any standard-based browser that runs on Microsoft Windows or Linux. In one embodiment, the browser is Mozilla Firefox, which is an open source browser that uses the Gecko layout engine to display web pages. Mozilla Firefox has a powerful Chrome/XUL framework and better compliance with the W3C standards than Microsoft Internet Explorer. In another embodiment, the browser 120 is Microsoft Internet Explorer, Firefox Mozilla, Opera, Apple Safari, Netscape Navigator, etc.

Embedded Script

The browser-embedded script 125 that is displayed on the web page is loaded from the network 115 or from the local drive. In one embodiment, the front-end scripting is Adobe Flash. The scripting language is Action Script in the binary form of a .SWF file that is customized for this invention. In another embodiment, the script 125 is any code that can interact with Middleware 205, e.g. JavaScript, Microsoft Active Server Pages (ASP), Python, Ruby, Pearl, C, etc.

The code is compiled into SWF format for playback from inside the web browser 120 using Flash. The SWF file contains graphics and code and supports exact positioning of graphical objects. The SWF file loads into the browser once. The media player then requests data from the middleware 205.

Web-Server

The web server 200 can be any standard-based web server that is compliant with HTTP/1.1. In one embodiment, the server is Lighttpd, which is an open-source single-threaded web server that is compatible with Linux, other Unix-like operating systems, and Microsoft Windows. A person of ordinary skill in the art would recognize that any web server that is compatible with Linux and Microsoft Windows could be substituted for Lighttpd.

In one embodiment, all Lighttpd modules except fcgi and access are disabled because they are unnecessary. The fcgi module interacts with the scripting language used by the middleware 205, i.e. PHP.

The web server 200 can be local, i.e. located on the same host as the web browser or it can be a networked web-server that is accessed via LAN or the Internet. For security reasons, when the web server 200 is configured as local only, the web server 200 is confined to bind to a local port with a number greater than 1024. Binding the port ensures that no local data is exposed to the network. The port numbers less than 1024 are well-known and inaccessible.

The web server 200 is the conduit between the web browser 120 and the local storage 130 through the middleware 205.

Middleware

The middleware 205 is a software application that functions as an intermediary between the web server 200 and application programs, e.g. a web browser. The middleware 205 can create documents for viewing in a web browser or receive documents from the web browser and interpret them for applications. The middleware 205 cocollates with the web server 200.

In one embodiment, the middleware 205 uses Hypertext Pre-Processor (PHP) as a scripting language. PHP is a server side scripting language for developing web pages. PHP is open source and is associated with a vast community for developer support. In another embodiment, the scripting language is ASPNBScript, Coldfusion, Perl, JSP, Java Servlets, a CGI script, etc.

XML Parser

Embedded script, e.g. Flash interacts with the middleware 205 using a markup language, e.g. eXtensible Markup Language (XML). XML is a specification for creating custom markup languages where users define their own elements. XML is recommended by the W3C. Other markup languages, e.g. HTML, XHTML can be used as long as they are compatible with the W3C standards.

The middleware 205 interprets the embedded script as instructions for performing actions using an XML parser 210. The XML parser 210 extracts and interprets the content of an XML file and can also verify that an XML document is well-formed. PHP includes a variety of XML parsers that can be used. In one embodiment, the middleware includes an XML parser 210 that is customized to function with specialty search engines.

Database Server

The database server 215 contains information relating to the audio and video clips. In one embodiment, the database server 215 is a relational database management system (RDMS) for storing indexable data entries related to the audio and video clips, e.g. timestamp, title, description, file-type, file size, user access history. The system recognizes the media saved in storage by using the information saved in the database server 215.

In one embodiment, the RDMS is SQLite, which is an open-source RDMS that uses the structured query language (SQL) for querying and modifying data and managing databases.

The database server 215 can be a local-bound database server stored on the client 105 or on a local network. Alternatively, the database server can be accessible via the Internet.

Storage Device

The storage device 130 can be any of local or network-mounted hard disk storage, a peripheral device, a dongle, a flash card, e.g. SD, xD, CF, CDROM/DVD, or other storage media as long as it is accessible through the computer's file system. The files are stored and accessed as structured by the PHP middleware.

### Accessing Media on a Storage Drive

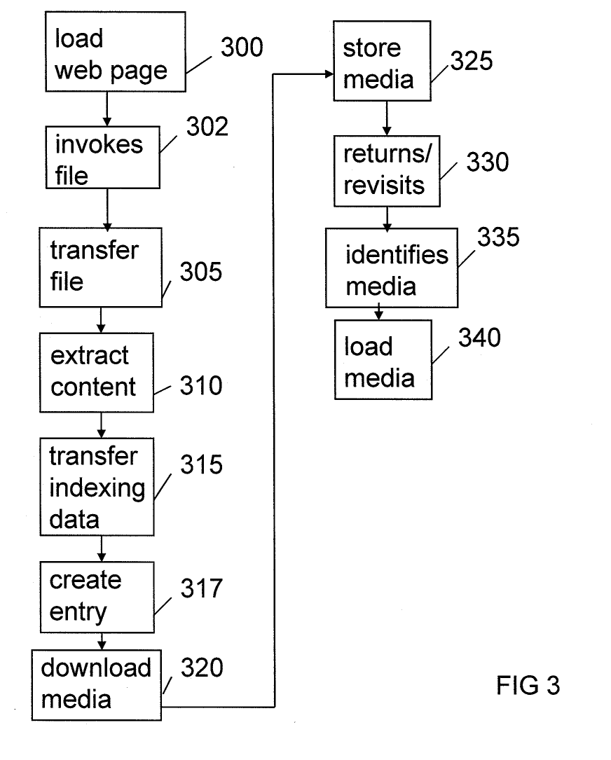

FIG. 3 is a flowchart that illustrates the steps for accessing media via a web browser where the embedded script can access contents stored on a storage drive.

The first time that a user selects a video or audio clip that is embedded in a web page, the following steps occur. The browser loads 300 a web page containing an embedded script, such as Flash. The browser invokes 302 the flash file. In one embodiment, the Flash file is further embedded in a regular HTML file. The script contains references to the middleware.

The XML file is primarily used for data, including metadata. The XML file is transferred 305 from the Internet server 225 to the middleware 205 over the Internet 115. The middleware 205 instructs the XML parser 210 to extract 310 content. The middleware 205 also transfers 315 indexing data to the RDBMS for storage and retrieval. The RDBMS creates 317 an entry for future referencing. Lastly, the middleware 205 controls the transfer of the media to storage, which downloads 320 and stores 325 a copy of the media for future retrieval. The storage device 130 can be local or network-mounted.

The next time that the user returns 330 to the webpage or revisits 330 the media file, the middleware 205 identifies 335 the location of the media on a storage device 130 based on indexing information stored in the database server 215. As a result, the user can view the video clip without waiting for a buffering process. The media file is directly loaded 340 without accessing the remote Internet server 225. This is especially useful for people to quickly access and playback favorite video clips. In addition, because the media is already stored on a local drive, the user views the video clip offline.

In one embodiment, the system stores a copy of the webpage as well as the media. The mechanism for storing the web page and the media can be as simple as placing a copy in the Favorites bin, which causes the system to log an entry in the RDBMS and store the file content.

In another embodiment, the system only stores a copy of the media if a user puts a copy of the web page in the user's favorites list. For example, if a user wants to watch a favorite YouTube video, once the user bookmarks the URL, the user can view the video even while the computer is offline.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A method for accessing a storage device from a script-embedded web page, comprising the steps of:
loading a web page that contains an embedded script, said script for streaming a media file;
transferring code comprising said media file and indexable data from an internet server to middleware, said middleware comprising a parser, said indexable data for identifying said media file;
said parser extracting said media file and said indexable data from said code;
said middleware transferring said indexable data to a database server;
said database server storing said indexable data;
said database server creating an entry for said indexable data;
downloading said media file to a storage device;
identifying said media file with said indexable data upon a subsequent visit to said web page; and
loading said media file from said storage device.

2. The method of claim 1, wherein said storage device is on said client.

3. The method of claim 1, wherein said storage device is accessible via a network-mounted drive.

4. The method of claim 1, wherein said media file is accessible offline once said media file is stored in said storage device.

5. The method of claim 1, wherein said database server comprises a relational database management system (RDMS).

6. The method of claim 5, further comprising:
storing any of the following entries on said RDMS: timestamp, title, description, file type, file size, and user access history.

7. A method for playing back a media file on a web page containing an embedded script by accessing a storage device, comprising the steps of:
loading a web page containing an embedded script for displaying a media file contained in compiled code;
selecting said media file for playback;
streaming said media file from an Internet server;
transmitting a copy of said media file to said storage device;
saving said media file as a favorite;
loading said web page again;
selecting said media file for playback; and
streaming said media file for display on said web page from said storage device,
wherein said media file is viewable when said client is offline.

8. A system for accessing an embedded script of a media file from a storage device comprising:
a web browser comprising an embedded script, said embedded script for loading a media file;
a web server for receiving said media file from an internet server;
middleware for transmitting said media file from said storage device to said web browser for playback, said middleware comprising a script parser for parsing said media file and indexing information from said compiled code, said compiled code written in a markup language;
a database server comprising a relational database management system for indexing information relating to said media file; and
said storage device for storing said media file.

9. The system of claim 8, wherein said storage device is locally mounted.

10. The system of claim 8, wherein said storage device is network mounted.

11. The system of claim 8, wherein said markup language is extensible markup language.

12. The system of claim 8, wherein said markup language is HyperText Markup Language.

13. The system of claim 8, wherein said markup language is Extensible HyperText Markup Language.

14. The system of claim 8, wherein said embedded script is Flash.

15. The system of claim 8, wherein said middleware comprises a scripting language.

16. The system of claim 14, wherein said middleware scripting language is Hypertext Pre-Processor (PHP).

17. The system of claim 14, wherein said middleware scripting language is from a group consisting of JavaScript, Python, Ruby, Perl, Microsoft Active Server Pages (ASP), and C.

18. The system of claim 8, wherein said media is viewable offline once a copy is saved in said storage device.

19. The system of claim 8, wherein said local drive comprises any of hard disk storage, a peripheral device, a dongle, and a flash card.

20. The system of claim 8, wherein said local drive comprises at least one flash card from a group consisting of SD, xD, CF, and CDROM/DVD.
